(19) United States
(12) Patent Application Publication
(10) Pub. No.: US 2019/0075725 A1
(43) Pub. Date: Mar. 14, 2019

(54) PROPULSION CONTROL SYSTEM AND TURF MAINTENANCE VEHICLE INCORPORATING SAME

(71) Applicant: THE TORO COMPANY, Bloomington, MN (US)

(72) Inventors: Ryan J. Volovsek, Inver Grove Heights, MN (US); Timothy J. Clift, Lino Lakes, MN (US)

(21) Appl. No.: 15/702,984

(22) Filed: Sep. 13, 2017

(51) Int. Cl. A01D 34/82; G05G 1/04; G05G 5/00; A01B 76/00

(52) U.S. Cl. CPC A01D 34/824; G05G 1/04; A01D 34/68; A01B 76/00; G05G 2505/00; G05G 5/005

(57) ABSTRACT

An operator control system for a turf maintenance vehicle. The control system may include a handle assembly, a first control lever, and a second control lever. The handle assembly may include a first hand grip defining a first grip axis and a second hand grip defining a second grip axis. A free end of each of the first and second hand grips may be located after of an attached end of each of the first and second hand grips. The first control lever may be pivotable about a first pivot axis that is parallel to the first grip axis and the second control lever may be pivotable about a second pivot axis that is parallel to the second grip axis.

### INCORPORATING SAME

Embodiments of the present disclosure relate generally to turf maintenance vehicles and, more particularly, to a control system operable to control propulsion of the vehicle.

### BACKGROUND

Self-propelled mid-size mowers (e.g., those having a deck cutting width of approximately 36-60 inches) are commonly used by homeowners and landscape professionals alike. While such mowers may be configured for a riding (including ride-on and ride-behind) or a walk-behind operator, walk-behind mowers have proven popular for many users. For example, walk-behind mowers have proven particularly adept at mowing large lawns with numerous obstacles (e.g., trees, shrubs, flowerbeds, and the like) which necessitate intricate trimming maneuvers, or when mowing lawns which may otherwise be ill-suited to high-speed riding mowers. Moreover, walk-behind mowers are often used when mowing areas with steep slopes.

One type of control system common among mid-size mowers uses two rearwardly extending, horizontal handles each equipped with a scissors-type lever. Each lever operatively controls one of the mower's drive wheels. Where the levers are configured as “normally engaged,” actuating (e.g., squeezing) one of the drive levers causes a proportional slowing of the corresponding drive wheel, permitting the mower to turn about that wheel. Alternatively, the levers may be “normally disengaged” such that actuating (e.g., squeezing) one of the drive levers causes a proportional increase in the rotational speed of the corresponding drive wheel. By independently controlling the drive wheels, forward and reverse speed changes, as well as left and right turning, may be accomplished.

While scissors-type lever control systems are more than adequate for their intended purpose, drawbacks remain. For instance, scissors-type levers, in general, may provide limited mechanical advantage in overcoming lever tension. Accordingly, when cutting a lawn with many trees, shrubs, or other obstacles that necessitate numerous turns, discomfort in the hands, wrists, and arms may occur. Scissors-type lever control systems may also be susceptible to variation in lever tension over the lever travel. Still further, depending on the position of each lever within its throw, the operator may not be able to grasp the respective lever with all fingers.

Other types of control systems are also known, for example, U.S. Pat. No. 5,511,367 to Powers et al. and U.S. Pat. No. 5,809,755 to Velke et al. disclose control systems having a generally transverse hand position. While addressing some of the above-identified problems, other issues with hand position and/or control actuation potentially remain. Further, U.S. Pat. No. 6,557,331 to Busboom et al. discloses a control system having control levers that pivot about an axis parallel to the corresponding hand grip, but the hand grips are positioned to extend upwards and towards the center of the mower, keeping the operator's arms in a bent and/or flexed position.

### SUMMARY

Embodiments described herein may provide a turf maintenance vehicle control system, and associated methods, that may simplify vehicle operation. For example, in one embodiment, an operator control system for a turf maintenance vehicle may include a handle assembly, a first control lever, and a second control lever. The handle assembly may include a first hand grip defining a first grip axis and a second hand grip defining a second grip axis. Each of the first and second hand grips may extend between an attached end and a free end. The free end of each of the first and second hand grips may be located aft of the attached end of each of the first and second hand grips, respectively. The first control lever may be associated with the first hand grip and may be pivotable about a first pivot axis. The first pivot axis may be parallel to the first grip axis. The second control lever may be associated with the second hand grip and may be pivotable about a second pivot axis. The second pivot axis may be parallel to the second grip axis.

In another embodiment, an operator control system for a turf maintenance vehicle may include a handle assembly, a first control lever, a second control lever, and a first locking device. The handle assembly may include a first hand grip defining a first grip axis and a second hand grip defining a second grip axis. Each of the first and second hand grips may extend at an angle of between 20 and 35 degrees from a horizontal plane when the turf maintenance vehicle is in an operating configuration. The first control lever may be associated with the first hand grip and may be pivotable about a first pivot axis. The first pivot axis may be parallel to the first grip axis. The second control lever may be associated with the second hand grip and may be pivotable about a second pivot axis. The second pivot axis may be parallel to the second grip axis. The first locking device may be pivotally coupled to the first hand grip about a lock pivot axis and adapted to position the first control lever in at least a first position. Either the first locking device or the first control lever may define a first notch and the other of the first locking device and the first control lever may include a protrusion. The protrusion may be positioned in the first notch when in the first position.

In yet another embodiment, a turf maintenance vehicle may include a chassis supported upon a ground surface by a plurality of ground-engaging members, a prime mover supported by the chassis, and an operator control system supported by the chassis and operably connected to the prime mover. The operator control system may be located aft of the prime mover and may include a handle assembly, a first control lever, and a second control lever. The handle assembly may include a first hand grip defining a first grip axis and a second hand grip defining a second grip axis. Each of the first and second hand grips may extend between an attached end and a free end. The free end of each of the first and second hand grips may be located aft of the attached end of each of the first and second hand grips, respectively. The first control lever may be associated with the first hand grip and may be pivotable about a first pivot axis. The first pivot axis may be parallel to the first grip axis. The second control lever may be associated with the second hand grip and may be pivotable about a second pivot axis. The second pivot axis may be parallel to the second grip axis.

The above summary is not intended to describe each embodiment or every implementation. Rather, a more complete understanding of illustrative embodiments will become apparent and appreciated by reference to the following Detailed Description of Exemplary Embodiments and Claims in view of the accompanying figures of the drawing.

### BRIEF DESCRIPTION OF THE VIEWS OF THE DRAWING

Exemplary embodiments will be further described with reference to the figures of the drawing, wherein:

FIG. 1 illustrates a perspective view of a turf maintenance vehicle (e.g., a walk-behind lawn mower) having a control system in accordance with embodiments of the present disclosure;

FIG. 2A illustrates a top perspective view of the exemplary control system of FIG. 1;

FIG. 2B illustrates a bottom perspective view of the control system of FIG. 2A;

FIG. 3A illustrates an exemplary locking device engaging a control lever in a neutral position in accordance with embodiments of the present disclosure;

FIG. 3B illustrates the locking device of FIG. 3A when the control lever is in a full forward position;

FIG. 3C illustrates the locking device of FIG. 3A when the control lever is in a full reverse position; and

FIG. 4 illustrates a perspective view of an exemplary locking device for use with control systems in accordance with embodiments of the present disclosure.

The figures are rendered primarily for clarity and, as a result, are not necessarily drawn to scale. Moreover, various structure/components, including but not limited to fasteners, electrical components (wiring, cables, etc.), and the like, may be shown diagrammatically or removed from some or all of the views to better illustrate aspects of the depicted embodiments, or where inclusion of such structure/components is not necessary to an understanding of the various exemplary embodiments described herein. The lack of illustration/description of such structure/components in a particular figure is, however, not to be interpreted as limiting the scope of the various embodiments in any way. Still further, “Figure x” and “FIG. x” may be used interchangeably herein to refer to the figure numbered “x.”

### DETAILED DESCRIPTION OF EXEMPLARY EMBODIMENTS

In the following detailed description of illustrative embodiments, reference is made to the accompanying figures of the drawing which form a part hereof. It is to be understood that other embodiments, which may not be described and/or illustrated herein, are certainly contemplated. Unless otherwise indicated, all numbers expressing quantities, and all terms expressing direction/orientation (e.g., vertical, horizontal, parallel, perpendicular, etc.) in the specification and claims are to be understood as being modified in all instances by the term “about.”

Generally speaking, embodiments of the present disclosure may be directed to control systems for controlling various aspects of a power turf maintenance vehicle (e.g., a walk-behind lawn mower). The control system may include control levers on left and right sides of the vehicle that operatively control rotational speed and direction of left and right drive wheels, respectively. Each of the left and right control levers may be ergonomically positioned for comfortable use by a walk-behind (or ride-behind, ride-on, etc.) operator. For example, each control lever may move, relative to a corresponding hand grip, such that an entire length of the control lever is parallel with the hand grip throughout the entire range of control lever movement. In other words, when the hand/fingers of the operator are used to actuate the control lever, each finger gripping the control lever travels the same distance because the control lever remains parallel with the hand grip.

Additionally, the control system may include a locking device corresponding to each of the left and right control levers. Each locking device may be used to temporarily lock its corresponding control lever into one of a plurality of positions. For example, the control levers may each actuate between: a full forward position (e.g., when the control lever is farthest from the hand grip) in which the corresponding drive wheel is powered to propel the vehicle in a forward direction (i.e., “normally engaged”); and a full reverse position (e.g., when the control lever is closest to the hand grip) in which the corresponding drive wheel is powered to propel the vehicle in a reverse direction. In one or more embodiments, the locking devices (or any other devices, components, structures, etc.) may restrict the motion of the control lever from moving past the full forward position (e.g., by restricting the distance the control lever may travel away from the hand grip) and the hand grip and/or locking device may restrict the motion of the control lever at the full reverse position (e.g., contacting the hand grip and/or locking device). Between the full forward position and the full reverse position, the locking device may lock the corresponding control lever into a neutral position in which no output is provided at the corresponding drive wheel. Furthermore, the control levers operate independently and, similarly, each corresponding locking device may be used independent of the other.

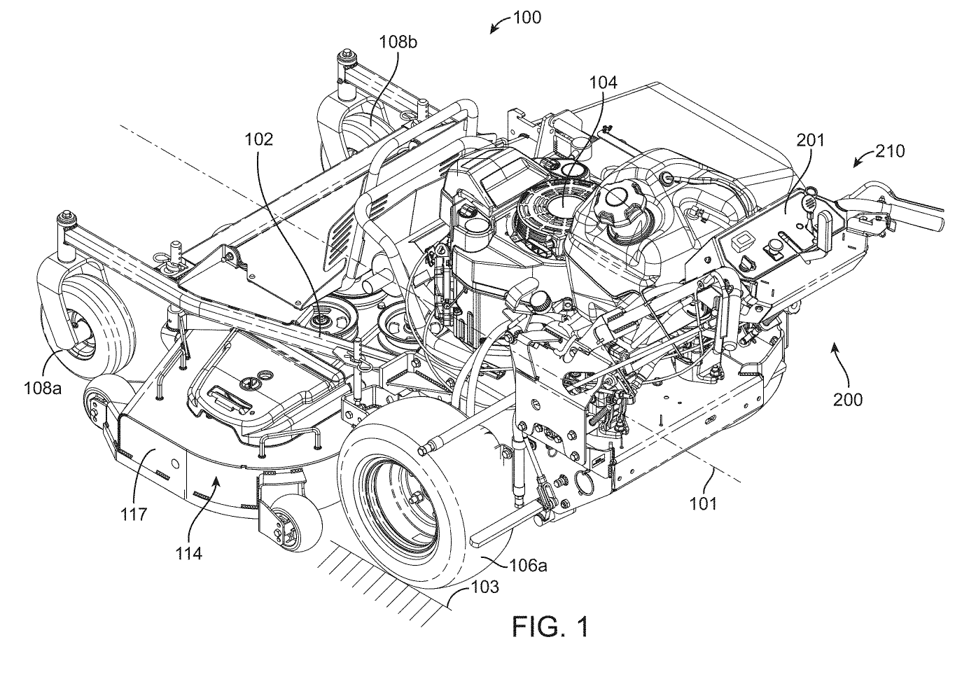

With reference to the figures of the drawing, wherein like reference numerals designate like parts and assemblies throughout the several views, FIG. 1 illustrates a turf maintenance vehicle in accordance with one exemplary embodiment of the present disclosure. While shown in this view as a self-propelled, turf maintenance vehicle, e.g., a zero-turning-radius walk-behind lawn mower 100 (also referred to herein simply as a “vehicle” or “mower”), such a configuration is not limiting. That is, while embodiments are described herein with respect to a walk-behind mower (or ride-behind), those of skill in the art will realize that this disclosure is equally applicable to other types of mowers, as well as to other types of turf maintenance vehicles (e.g., aerators, spreader/sprayers, dethatchers, debris management systems (e.g., blowers, vacuums, sweeper, etc.), general purpose utility vehicles, and the like) without limitation.

It is noted that the term “comprises” (and variations thereof) does not have a limiting meaning where this term appears in the accompanying description and claims. Further, “a,” “an,” “the,” “at least one,” and “one or more” are used interchangeably herein. Moreover, relative terms such as “left,” “right,” “front,” “fore,” “forward,” “rear,” “aft,” “rearward,” “top,” “bottom,” “side,” “upper,” “lower,” “above,” “below,” “horizontal,” “vertical,” and the like may be used herein and, if so, are from the perspective of one operating the mower 100 while the mower is in an operating configuration, e.g., while the mower 100 is positioned such that wheels 106 and 108 rest upon a generally horizontal ground surface 103 as shown in FIG. 1. These terms are used only to simplify the description, however, and not to limit the interpretation of any embodiment described.

Still further, the suffixes “a” and “b” may be used throughout this description to denote various left- and right-side parts/features, respectively. However, in most pertinent respects, the parts/features denoted with “a” and “b” suffixes are substantially identical to, or mirror images of, one another. It is understood that, unless otherwise noted, the description of an individual part/feature (e.g., part/feature identified with an “a” suffix) also applies to the opposing part/feature (e.g., part/feature identified with a “b” suffix). Similarly, the description of a part/feature identified with no suffix may apply, unless noted otherwise, to both the corresponding left and right part/feature.

As shown in FIG. 1, the mower 100 may include a frame or chassis 102 that supports a prime mover. While the prime mover may be configured as most any source of power (e.g., an electric motor), it is, in the embodiment shown, configured as an internal combustion engine 104. The chassis 102 may be supported upon the ground surface 103 by ground-engaging members that, in one embodiment, include left and right ground-engaging drive wheels 106 that may be coupled to left and right sides of a rear portion of the mower 100 (e.g., only left drive wheel 106a visible in FIG. 1, but right drive wheel is generally a mirror image). The drive wheels 106 may be independently powered by the engine (e.g., via one or more hydraulic motors, transmissions, transaxles, or the equivalent) so that the drive wheels 106 may rotate (relative to the chassis) and selectively propel the mower 100 over the ground surface 103. While a single prime mover (e.g., engine 104) may power both the vehicle wheels and the implement (cutting deck), other embodiments may utilize two or more prime movers (e.g., different prime movers for propulsion and for implement power) without departing from the scope of this disclosure. In the illustrated embodiment, a pair of front swiveling ground-engaging members (e.g., caster wheels 108a, 108b) may support a front portion of the mower 100 in rolling engagement with the ground surface 103. Of course, other drive configurations (e.g., actively steered front and/or rear wheels, tri-wheel configurations) and vehicles using ground-engaging members other than wheels (e.g., tracks), are certainly contemplated within the scope of this disclosure.

An implement adapted to perform a maintenance task, e.g., a lawn mower cutting deck 114, may be connected to, or otherwise carried by, the chassis 102 of the mower 100, e.g., generally between the drive wheels 106 and the caster wheels 108. The cutting deck 114 may include a deck housing 117 that defines a downwardly-opening cutting chamber (not shown). The cutting chamber may partially surround one or more rotatable cutting blades (also not shown), each attached to a blade spindle assembly as is known in the art. Of course, other cutting decks (e.g., out-front decks, towed decks, reel units, etc.), as well as other implements, are contemplated within the scope of this disclosure. During operation, power is selectively delivered to the cutting deck 114 (e.g., to the spindle assemblies) and the drive wheels 106, whereby the cutting blades rotate at a speed sufficient to sever grass and other vegetation as the deck passes over the ground surface 103. Typically, the cutting deck 114 includes an operator-selectable height-of-cut control system to allow deck height adjustment relative to the ground surface 103.

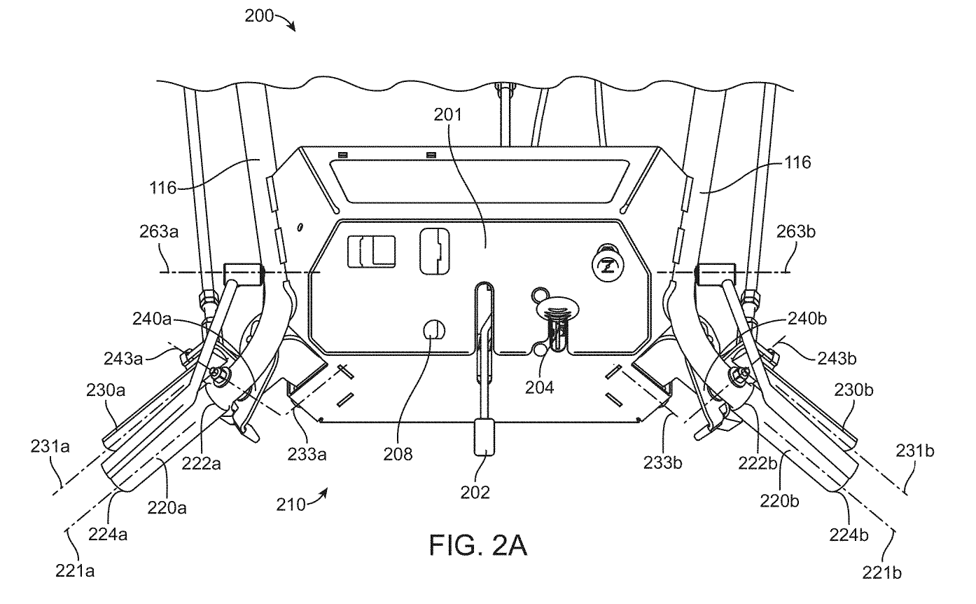

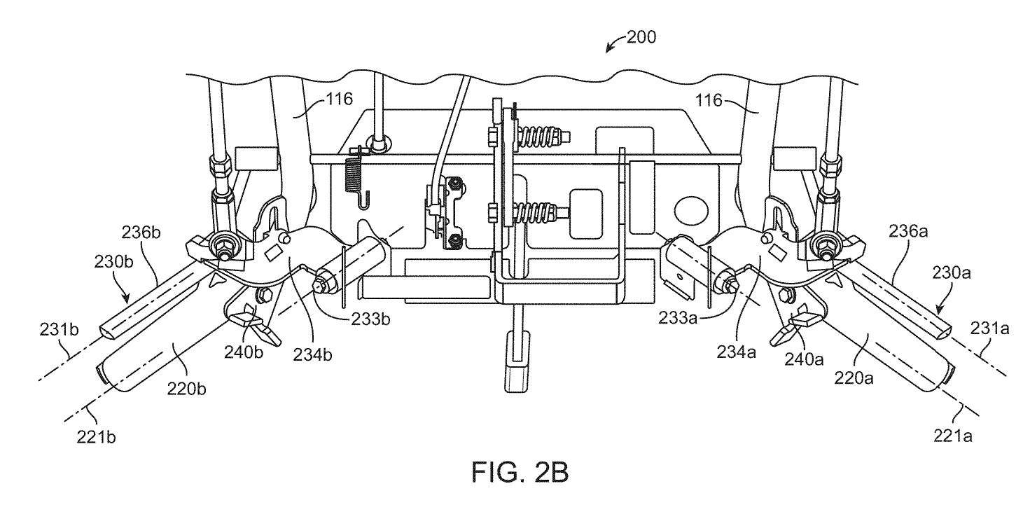

With this general overview, an embodiment of an exemplary control system 200 will now be described. As shown in FIG. 1, the control system 200 may include a control area or panel 201, an exemplary embodiment of which is illustrated in more detail in FIG. 2A. The control panel 201 may be positioned on the mower at a location that is conveniently accessible to the operator while walking or standing behind the mower 100. The control system 200 may include operator controls that are mounted to upwardly extending portions of the frame 102 near the rear end of the mower 100 such that the controls are located within comfortable reach of the operator. For example, the control system 200 may include a handle assembly 210 extending from the frame 102 to a position on either side of the operator with the control panel 201 located therebetween.

While not wishing to be bound to any specific configuration, the control panel 201 may include operator-selectable controls (e.g., switches) configured to provide inputs to the control system 200. For example, the control panel 201 may include a key/ignition switch 208 for starting the engine 104 or otherwise activating the vehicle's electrical system. Moreover, the control panel may include a drive wheel speed lever 202 (e.g., to control the maximum speed of each drive wheel at the full forward position) and a throttle 204 (e.g., to control engine speed to the cutting blades of the mower). Further, the mower 100 may include a parking brake handle, e.g., to selectively activate a brake when the vehicle is parked. Other controls not central to this disclosure may also be provided.

As shown in FIGS. 2A and 2B, the handle assembly 210 may include a first (e.g., left) hand grip 220a and a second (e.g., right) hand grip 220b. The first hand grip 220a may define (e.g., extend along) a first grip axis 221a and the second hand grip 220b may define (e.g., extend along) a second grip axis 221b. As described above, the hand grips (and other parts/features) may be referred to generically or collectively without the suffix, e.g., “hand grip 220” and may refer to either or both the first hand grip 220a and the second hand grip 220b. Furthermore, it is understood that, e.g., the description of the first hand grip 220a, also applies to the second hand grip 220b, and vice-versa.

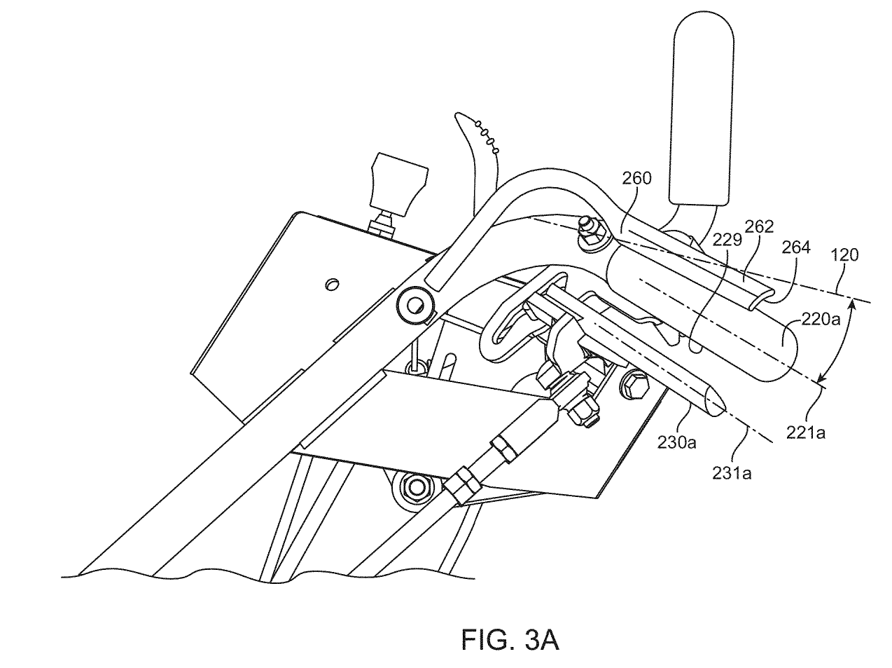

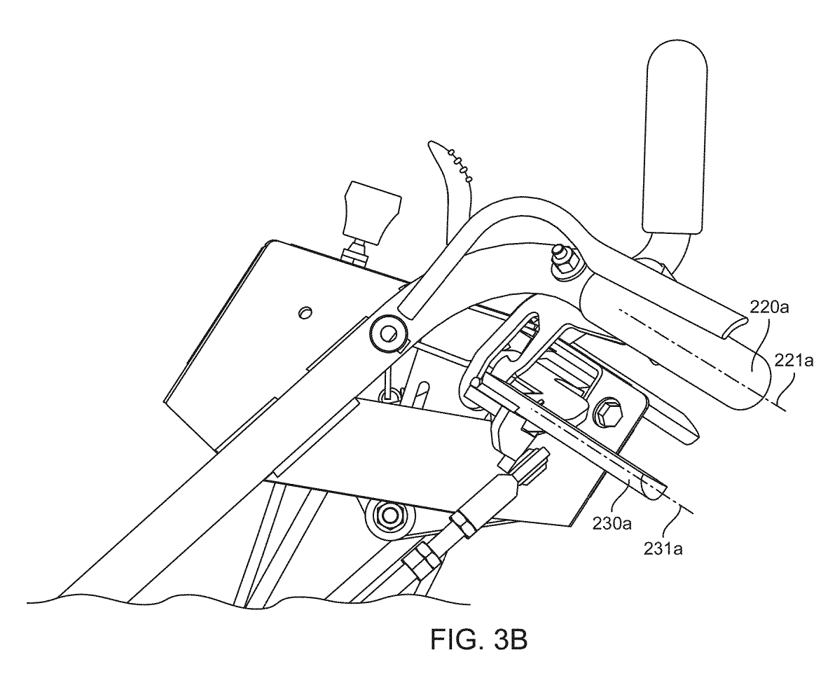

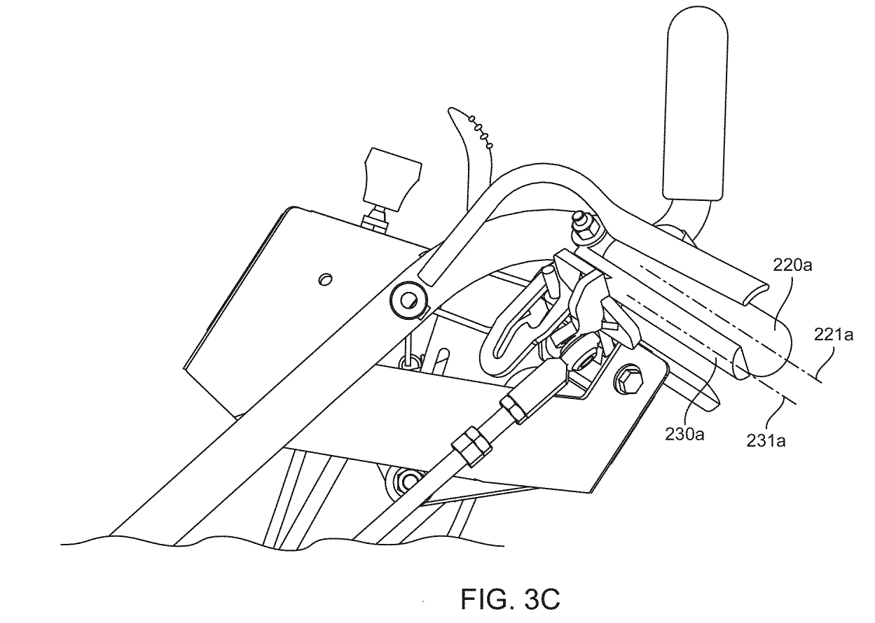

Each of the first and second hand grips 220 (e.g., grip axes 221) may be positioned in any suitable way such that an operator may grasp the hand grip 220 when the operator's arms are extending downwards (e.g., generally vertical). In other words, the hand grips 220 may extend rearwardly, outwardly, and downwardly when the mower 100 is in an operating configuration (e.g., upright on the ground surface 103 as illustrated in FIG. 1). For example, each of the first and second hand grips 220 (e.g., grip axes 221) may extend at an angle of about 20 degrees to about 35 degrees from a horizontal plane 120 (e.g., as shown in FIG. 3A) when the mower 100 is in the operating configuration (e.g., at an angle of about 24 to 32 degrees from a horizontal plane 120). Further, each of the first and second hand grips 220 (e.g., grip axes 221) may extend at an angle of about 40 degrees to about 55 degrees from a vertical plane extending along a longitudinal axis 101 of the mower 100 (e.g., at an angle of about 45 to 50 degrees from the vertical plane extending along the longitudinal axis 101 of the mower 100).

This position or orientation of the hand grips 220 may provide an ergonomic, comfortable position for the operator's arms and hands when grasping the hand grips 220 and operating the mower 100. For example, the arms of the operator may be positioned in a more relaxed or generally extended position (e.g., a generally vertical orientation). Furthermore, the position or orientation of the hand grips 220 may allow the operator to easily apply his or her bodyweight as a downward force to lift or “float” the cutting deck 114 of the mower 100. For example, a high amount of force may be applied to the hand grips 220 because the operator is in a centered position over the grip axes 221 such that the operator may be able to easily apply a downward force.

Further, each of the first and second hand grips 220a, 220b may be described as extending between an attached end (222a, 222b, respectively) and a free end (224a, 224b, respectively). The attached end 222 of each hand grip 220 may be coupled to (or be formed integral with) a handle tube 116 (e.g., 116a and 116b) connected to, and extending rearwardly and upwardly from, the frame 102. Accordingly, each handle tube 116 connects its respective hand grip 220 to the frame 102.

In one or more embodiments, the free end 224 of each of the hand grips 220 may be located aft of (e.g., behind) the attached end 222. Positioning the free end 224 behind the attached end 222 may help to prevent the hand grips 220 from inadvertent contact, e.g., becoming caught when the mower 100 is traveling in a forward direction. Each of the first and second hand grips 220a, 220b may also be described as extending rearwardly away from each other and away from a longitudinal axis 101 (e.g., as shown in FIG. 1) of the mower 100. In other embodiments, the free end 224 could be positioned in front of the attached end 222. In other words, the arm 116 may connect to the attached end 222 at a rear most part of the mower 100 and the hand grips 220 may extend forward therefrom.

The control system 200 may also include a first control lever 230a (e.g., associated with the first hand grip 220a) and a second control lever 230b (e.g., associated with the second hand grip 220b). The control levers 230 may be configured to control power delivery (i.e., speed and direction) to the corresponding drive wheels 106. For example, the first control lever 230a may control power delivery to the left drive wheel 106a and the second control lever 230b may control power delivery to the right drive wheel 106b. The first and second control levers 230a, 230b may be operably coupled, e.g., to separate hydraulic pumps, to independently and proportionally vary a velocity of the drive wheels 106a, 106b, respectively. Further, the control levers 230 may be operable to independently control a rotational direction of their respective drive wheels 106 via manipulation of the mower's drive system as is known in the art. Specifically, the control lever 230 may be manipulated (e.g., pivoted about an axis) between a full forward position, a neutral position, and a full reverse position. As each control lever 230 moves between these positions, the drive system may proportionally command the respective drive wheel 106 to rotate at a speed (and direction) corresponding to the position of the particular control lever 230.

Each of the first and second control levers 230a, 230b may include a connection portion 234a, 234b pivotally coupled to a portion of the mower 100 and a handle portion 236a, 236b extending therefrom (e.g., as shown in FIG. 2B) configured to be grasped by the operator. Further, each of the first and second control levers 230a, 230b (e.g., the connection portion 234a, 234b) may be pivotally coupled to the mower 100 (e.g., to the handle assembly 210 or the control panel 201) such that the control levers 230 may pivot between the full forward position, the neutral position, and the full reverse position. For example, the control lever 230 (e.g., the connection portion 234) may be pivotally coupled to the handle assembly 210 such that the first control lever 230a may pivot about a first pivot axis 233a and the second control lever 230b may pivot about a second pivot axis 233b. Moreover, the first pivot axis 233a, about which the first control lever 230a may pivot, may be parallel to the first grip axis 221a, while the second pivot axis 233b, about which the second control lever 230b may pivot, may be parallel to the second grip axis 221b.

The handle portions 236a, 236b of the first and second control levers 230a, 230b may also define (e.g., extend along) first and second lever axes 231a, 231b, respectively. Furthermore, in some embodiments, the first lever axis 231a may be parallel to the first grip axis 221a and the second lever axis 231b may be parallel to the second grip axis 221b. In other words, the first control lever 230a (e.g., the handle portion 236a) may extend parallel to the first hand grip 220a and the second control lever 230b (e.g., the handle portion 236b) may extend parallel to the second hand grip 220b. Because of the parallel orientation of the corresponding grip axes 221, pivot axes 233, and lever axes 231, the control lever 230 may remain generally parallel to the respective hand grip 220 as the control lever 230 is actuated relative to the hand grip 220. As a result, the force required to manipulate each control lever 230 (e.g., the lever tension) may be uniform along the control lever 230 throughout the travel of the control lever 230. Moreover, because each lever axis 231a, 231b is parallel to the respective grip axis 221a, 221b, the operator may be able to grasp the control lever 230 with most, if not all, fingers regardless of the specific position of the control lever 230 relative to the hand grip 220. In contrast, if the control lever 230 were at an angle to the hand grip 220 (e.g., a scissor-type arrangement), the distance (between the control lever 230 and hand grip 220), as well as the force required (to manipulate the control lever 230) may vary depending on the position of a specific finger along the hand grip 220. For example, with respect to a scissor-type control lever, in order for each finger to create an even torque applied across the entire scissor-type control lever, a larger force on the control lever is required closer to the control lever pivot axis than farther away from the control lever pivot axis (e.g., fingers closer to the control lever pivot axis may experience a greater required force than the fingers farther from the control lever pivot axis).

In one or more embodiments, the first control lever 230a may be positioned or located below the first hand grip 220a and the second control lever 230b may be positioned or located below the second hand grip 220b (e.g., when the mower 100 is in the operating configuration). In such embodiments, the control lever 230 is positioned below the hand grip 220 such that the fingers of the operator engage the control lever 230 while the base of the hand abuts the hand grip 220 (e.g., when the mower 100 is in the normal operating configuration). This orientation may allow the operator to manipulate the control lever 230 by simply moving his or her fingers.

The hand grip 220 and the control lever 230 may be shaped in any suitable manner that permits the control lever 230 to be moved relative to the hand grip 220. For example, the control lever 230 may define a shape that is complementary to the hand grip 220 such that when the control lever 230 and the hand grip 220 are adjacent or abut, the combined shape does not present large discontinuities or protrusions that may fatigue the hands over time. In some embodiments, the control lever 230 may include a concave surface that conforms to the circular shape of the hand grip 220.

As described herein, the control lever 230 may pivot relative to the hand grip 220 into different positions (e.g., full forward position, neutral position, full reverse position). For example, as shown in FIG. 3A, the first control lever 230a is shown located in a first position (e.g., a neutral position). The neutral position of the control lever 230 may be located in a position somewhere between full reverse position (e.g., near or abutting the hand grip 220) and full forward position (e.g., fully extended away from the hand grip 220). Specifically, the neutral position may be closer to the full reverse position (e.g., closer to the hand grip 220) than the full forward position to provide a greater range of motion (e.g., resulting in a greater variation of speed) for the control levers 230 to drive the drive wheels forward than reverse (i.e., may desire twice as much forward speed variation than reverse speed variation). In the neutral position, no driving power is delivered to the respective wheel 106. As a result, the respective drive wheel 106 is stationary.

As shown in FIG. 3B, the first control lever 230a is shown located in a second position (e.g., the full forward position). In the full forward position, driving power is delivered to the respective driving wheel 106 for maximum propulsion of that wheel in the forward direction. The control lever 230 may be biased towards the full forward position so that the operator may maintain the control lever 230 in the full forward position without applying a constant force to the control lever 230. When both of the control levers 230 are in the full forward position (or at equivalent positions between the neutral position and the full forward position), the mower 100 will travel in the forward direction (e.g., at a maximum specified speed when in the full forward position). When only one of the control levers 230 (e.g., the first/left control lever 230a) is in the full forward position (e.g., the other control lever (e.g., the second/right control lever 230b) is in a position anywhere other than its full forward position), the mower 100 will execute, e.g., a right turn. Additionally, the control lever 230 may be held anywhere between the neutral position and the full forward position for varying incremental forward speeds. In other words, the closer the control lever 230 is to the full forward position, the faster the respective drive wheel 106 rotates in a forward direction and the closer the control lever 230 is to the neutral position (e.g., between the neutral and full forward positions), the slower the respective drive wheel 106 rotates in a forward direction.

As shown in FIG. 3C, the first control lever 230a is located in a third position (e.g., the full reverse position). In the full reverse position, driving power is delivered to the respective drive wheel 106 to propel the mower 100 in the reverse direction. By forcing the control lever 230 (squeezing) towards the hand grip 220, the control lever 230 is placed into the full reverse position. When both of the control levers 230 are in the full reverse position (or at equivalent positions between the neutral position and the full reverse position), the mower 100 will travel in the reverse direction. When only one of the control levers 230 is in the full reverse position (e.g., the other control lever is in any other position that its full reverse position), the mower 100 will turn in a direction opposite the control lever that is in the full reverse position. Additionally, the control lever 230 may be held anywhere between the neutral position and the full reverse position for varying incremental reverse speeds. In other words, the closer the control lever 230 is to the full reverse position, the faster the drive wheel 106 rotates in a reverse direction and the closer the control lever 230 is to the neutral position (e.g., between the neutral and full reverse positions), the slower the respective drive wheel 106 rotates in a reverse direction.

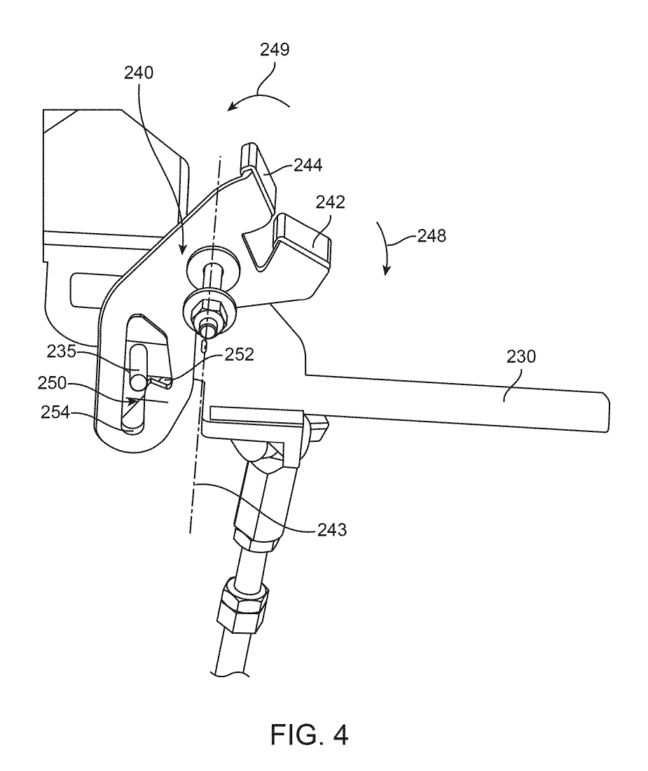

The control system 200 may also include a first locking device 240a associated with the first control lever 230a and a second locking device 240b associated with the second control lever 230b, as illustrated in FIGS. 2A and 2B. An enlarged and unobstructed view of the first locking device 240a is illustrated in FIG. 4. The locking device 240 may be adapted to position the respective control lever 230 in different positions. In other words, the locking device 240 may assist in temporarily locking the control lever 230 in a position to, e.g., ease strain on the operator during continued use, lock the mower in neutral, etc. For example, the locking device 240 may be adapted to position or lock the respective control lever 230 in at least the first position (e.g., the neutral position). In some embodiments, the locking device 240 may be adapted to position, restrict, or lock the respective control lever 230 in the second position (e.g., the full forward position). Because the control lever 230 is biased to extend towards and stop at the full forward position, the control lever 230 may not contact the locking device 240 when in the full forward position. In other words, the control lever 230 itself may set the boundaries of the full extension or full forward position of the control lever 230 (e.g., to limit the maximum distance the operator's hand must span to interact with both the control lever 230 and the hand grip 220).

The locking device 240 may be coupled to the hand grip 220 proximate the control lever 230. Each of the first and second locking devices 240a, 240b may be adapted to pivot about first and second lock pivot axes 243a, 243b, respectively. Each of the first and second lock pivot axes 243a, 243b may be oriented perpendicular to the first and second grip axes 221a, 221b. The locking device 240 may be biased in any suitable way to configure the control lever 230 into a “default” position. For example, the locking device 240 may be biased to pivot in such a way that positions its respective control lever 230 in the neutral position (or, e.g., the full forward position) when the control lever 240 is released by the operator.

As illustrated in FIG. 4, the locking device 240 may include an aperture 250 having a first notch 252 and a second notch 254. Further, the control lever 230 may include a protrusion 235 extending through the aperture 250 (e.g., of the locking device 240). In some embodiments, the control lever 230 may include the aperture 250 and the locking device 240 may include the protrusion 235. When the protrusion 235 is positioned within the first notch 252, the control lever 230 may be in the first position (e.g., the neutral position); and when the protrusion 235 is positioned in the second notch 254, the control lever 230 may be in the second position (e.g., the full forward position). However, in some embodiments, the protrusion 235 may not contact a base of the second notch 254 when the control lever 230 is in the full forward positioned, as described herein. The notches 252, 254 and protrusion 235 may be any shape or size that is suitable such that the protrusion 235 is engaged within the notches 252, 254. In one or more embodiments, the aperture 250 may be enclosed or not enclosed (e.g., such that the protrusion 235 may extend out of the aperture 250 (e.g., because the aperture 250 is not enclosed) to position the control lever 230 in the full forward position).

The locking device 240 may be pivotally coupled to the hand grip 220 (e.g., about the lock pivot axis 243) such that the locking device 240 may be adapted to pivot and position the protrusion 235 of the control lever 230 in either one of the first notch 252 (e.g., to configure the control lever 230 in the neutral position) or the second notch 254 (e.g., to configure the control lever 230 in the full forward position). Because the control lever 230 is biased to extend away from the hand grip 220, the operator may force the control lever 230 towards the hand grip 220 and the locking device 240 may be rotated such that upon release of the control lever 230, the protrusion 235 of the control lever 230 may be positioned into the first notch 252 or the second notch 254.

The locking device 240 may further include a first extended portion 242 and a second extended portion 244 that are configured to assist in rotating the locking device 240 about the lock pivot axis 243. For example, a force applied to the first extended portion 242 (e.g., via the operator's thumb) results in a rotation of the locking device 240 in a direction 248 that aligns the protrusion 235 to be positioned in the first notch 252 (e.g., the neutral position as illustrated in FIG. 3A). Also, for example, a force applied to the second extended portion 244 results in a rotation of the locking device 240 in a direction 249 that aligns the protrusion 235 to be positioned in the second notch 254 (e.g., the full forward position as illustrated in FIG. 3B). In other words, the first and second extended portions 242, 244 may be configured to rotate the locking device 240 in opposite directions to manipulate the locking device 240 such that the control lever 230 may be positioned in the neutral or full forward positions. Further, in one or more embodiments, the first and second extended portions 242, 244 may extend from the lock pivot axis 243 in a direction opposite the aperture 250. Further yet, while the present locking device 240 only illustrates one functional notch and, therefore, only one position (e.g., the neutral position), the locking device 240 may be adapted to position the control lever 230 in any number of positions.

The control system 200 may also include one or more secondary levers 260 (e.g., operator presence levers) associated with one or both of the first hand grip 220a and the second hand grip 220b as illustrated in FIG. 3A. The one or more secondary levers 260 may be configured to terminate mower operation, e.g., stop the engine 104, in some circumstances unless operator presence is detected (e.g., by depressing the one or more secondary levers 260). For example, the one or more secondary levers 260 may be coupled to an engine interlock system to terminate power to the engine. The one or more secondary levers 260 may be manipulated between an open configuration (e.g. positioned away from the hand grip 220) and a closed configuration (e.g., contacting the hand grip 220). When the one or more secondary levers 260 is in the open configuration, power to the engine may be terminated (unless the control lever 230 is in the neutral position). When the one or more secondary levers 260 is in the closed configuration, the engine maintains power (e.g., because the operator is considered to be present). The one or more secondary levers 260 may be biased into the open configuration so that the operator must always be in contact with the one or more secondary levers 260 (e.g., to position the one or more secondary levers 260 into the closed position) to maintain power to the engine.

The one or more secondary levers 260 may be positioned proximate the respective hand grip 220 and opposite the control lever 230. The one or more secondary levers 260 may be pivotable about a secondary lever axis 263 (e.g., as shown in FIG. 2A) such that the one or more secondary levers 260 may be manipulated relative to the hand grip 220. The secondary lever axis 263 may be generally transverse to the longitudinal axis 101 of the mower 100. In one or more embodiments, the secondary lever axis 263 may be parallel to or perpendicular to the grip axis 221. Further, the one or more secondary levers 260 may define a gripping portion 262 and an inner surface 264 opposite the gripping portion 262. The inner surface 264 may define a shape that conforms to an outer surface 229 of the hand grip 220 to form a smooth transition between the one or more secondary levers 260 and the hand grip 220. The secondary lever(s) 260 described herein are exemplary only as the use of various other operator presence systems, now known or later developed, may be suitable alternatives.

Illustrative embodiments are described and reference has been made to possible variations of the same. These and other variations, combinations, and modifications will be apparent to those skilled in the art, and it should be understood that the claims are not limited to the illustrative embodiments set forth herein.

What is claimed is:

1. An operator control system for a turf maintenance vehicle, the control system comprising:
a handle assembly comprising a first hand grip defining a first grip axis and a second hand grip defining a second grip axis, wherein each of the first and second hand grips extends between an attached end and a free end, wherein the free end of each of the first and second hand grips is located aft of the attached end of each of the first and second hand grips, respectively;
a first control lever associated with the first hand grip, the first control lever pivotable about a first pivot axis, wherein the first pivot axis is parallel to the first grip axis; and
a second control lever associated with the second hand grip, the second control lever pivotable about a second pivot axis, wherein the second pivot axis is parallel to the second grip axis.

2. The control system of claim 1, wherein the first control lever is located below the first hand grip and the second control lever is located below the second hand grip when the turf maintenance vehicle is in an operating configuration.

3. The control system of claim 1, wherein the first control lever defines a first lever axis parallel to the first grip axis.

4. The control system of claim 1, wherein the second control lever defines a second lever axis parallel to the second grip axis.

5. The control system of claim 1, further comprising a first locking device adapted to position the first control lever in at least a first position.

6. The control system of claim 5, wherein the first locking device is coupled to the first hand grip.

7. The control system of claim 5, wherein the first locking device is adapted to pivot about a lock pivot axis that is perpendicular to the first grip axis.

8. The control system of claim 5, wherein the first locking device defines an aperture having a first notch and a second notch, wherein the first control lever comprises a protrusion extending through the aperture of the first locking device, wherein the protrusion of the first control lever is positioned in the first notch when in the first position and is positioned in the second notch when in a second position.

9. The control system of claim 8, wherein the first locking device is rotatably coupled to the first hand grip such that the first locking device is adapted to pivot and position the protrusion of the first control lever in the first position or the second position.

10. The control system of claim 9, wherein the first locking device comprises a first extended portion configured to rotate the first locking device such that the protrusion is positioned in the first position and a second extended portion configured to rotate the first locking device such that the protrusion is positioned in the second position.

11. The control system of claim 10, wherein the first and second extended portions are configured to rotate the first locking device in opposite directions.

12. The control system of claim 11, further comprising a second locking device adapted to lock the second control lever in at least a first position.

13. The control system of claim 1, further comprising one or more secondary lever having a gripping portion, wherein the one or more secondary lever is associated with one or both of the first hand grip and the second hand grip, wherein the one or more secondary lever is pivotable about a secondary lever axis transverse to a longitudinal axis of the turf maintenance vehicle.

14. The control system of claim 13, wherein the first hand grip defines a first cross-sectional shape and the gripping portion of the one or more secondary levers defines a second cross-sectional shape that conforms to an outer surface of the first cross-sectional shape.

15. An operator control system for a turf maintenance vehicle, the control system comprising:
a handle assembly comprising a first hand grip defining a first grip axis and a second hand grip defining a second grip axis, wherein each of the first and second hand grips extends at an angle of between 20 and 35 degrees from a horizontal plane when the turf maintenance vehicle is in an operating configuration;
a first control lever associated with the first hand grip, the first control lever pivotable about a first pivot axis, wherein the first pivot axis is parallel to the first grip axis;
a second control lever associated with the second hand grip, the second control lever pivotable about a second pivot axis, wherein the second pivot axis is parallel to the second grip axis; and
a first locking device pivotally coupled to the first hand grip about a lock pivot axis and adapted to position the first control lever in at least a first position, wherein either the first locking device or the first control lever defines a first notch, wherein the other of the first locking device and the first control lever comprises a protrusion, wherein the protrusion is positioned in the first notch when in the first position.

16. The control system of claim 15, wherein the lock pivot axis is perpendicular to the first grip axis.

17. The control system of claim 15, wherein the first locking device is pivotally coupled to the first hand grip such that the first locking device is adapted to pivot and position the protrusion of the first control lever in the first position or the second position.

18. The control system of claim 15, wherein each of the first and second hand grips extends rearwardly when the turf maintenance vehicle is in an operating configuration

19. A turf maintenance vehicle comprising:
a chassis supported upon a ground surface by a plurality of ground-engaging members;
a prime mover supported by the chassis; and
an operator control system supported by the chassis and operably connected to the prime mover, wherein the operator control system is located aft of the prime mover, wherein the operator control system comprises:
a handle assembly comprising a first hand grip defining a first grip axis and a second hand grip defining a second grip axis, wherein each of the first and second hand grips extends between an attached end and a free end, wherein the free end of each of the first and second hand grips is located aft of the attached end of each of the first and second hand grips, respectively;
a first control lever associated with the first hand grip, the first control lever pivotable about a first pivot axis, wherein the first pivot axis is parallel to the first grip axis; and
a second control lever associated with the second hand grip, the second control lever pivotable about a second pivot axis, wherein the second pivot axis is parallel to the second grip axis.
